(19) United States
(12) Patent Application Publication
(10) Pub. No.: US 2024/0344267 A1
(43) Pub. Date: Oct. 17, 2024

(54) SYNTHETIC RESIN LEATHER AND METHOD FOR MANUFACTURING THE SAME

(71) Applicants: OKAMOTO INDUSTRIES, INC., Tokyo (JP); HONDA MOTOR CO., LTD., Tokyo (JP)

(72) Inventors: Hironori KOBAYASHI, Tokyo (JP); Naoto MATSUMOTO, Tokyo (JP); Shin NAKAYA, Tokyo (JP); Yoritaka ASADA, Tokyo (JP); Tomoyuki UEMURA, Tokyo (JP)

(73) Assignees: OKAMOTO INDUSTRIES, INC., Tokyo (JP); HONDA MOTOR CO., LTD., Tokyo (JP)

(21) Appl. No.: 18/630,471

(22) Filed: Apr. 9, 2024

(30) Foreign Application Priority Data
Apr. 11, 2023 (JP) 2023-064072

(51) Int. Cl. D06N 3/00; B32B 3/30; B32B 27/30; D06N 3/06

(52) U.S. Cl. CPC D06N 3/0077; B32B 3/30; B32B 27/304; D06N 3/06; B32B 2307/554; B32B 2437/02; B32B 2601/00; D06N 2209/1685

(57) ABSTRACT

Synthetic resin leather includes a base material, and a skin layer that is stacked on the base material and is made of a synthetic resin capable of being elastically deformed. Multiple micro recess parts are intermittently and regularly formed on a surface of the skin layer. The multiple micro recess parts form multiple bottom face parts that are located at a substantially constant depth from the surface of the skin layer, and multiple inner side face parts that extend from the surface of the skin layer to the multiple bottom face parts and are capable of being elastically deformed.

### BACKGROUND OF THE INVENTION

### Technical Field

The present invention relates to synthetic resin leather to be used as vehicle interior materials for automobiles and the like, upholstery for chairs, sofas, and the like, shoe upper materials, and skin materials for stationery (e.g., notebooks), smartphone cases, and the like, and a manufacturing method for manufacturing the same.

### Description of the Related Art

A conventional example of this type of synthetic resin leather is a synthetic resin skin material and a method for manufacturing the same disclosed in Japanese Patent Application Publication No. 2020-111024 and the like, and the synthetic resin skin material has a surface with an embossed pattern formed by pressing an embossing roller engraved with an embossed pattern, which is a leather-like uneven pattern, against the skin layer that is provided on a base cloth and contains a vinyl chloride resin as a main component, with the surface of the embossing roller being heated.

Another example thereof is a leather-like sheet and a method for manufacturing the same disclosed in Japanese Patent Application Publication No. H08-060557 and the like, and the leather-like sheet has a nubuck-like external appearance formed by making the surface of a sheet material uneven through embossing performed using a pattern embossing roller or the like, followed by napping performed using sandpaper, a brush, or the like.

### SUMMARY OF THE INVENTION

However, in Japanese Patent Application Publication No. 2020-111024 above, the convex parts in the fine uneven pattern formed through embossing are incapable of being elastically deformed and are continuously arranged, and a user does not feel the movement because of low elasticity when touching the fine uneven pattern with the hand, finger, or the like, thus posing a problem in that flat feel (i.e., he/she feels the entire surface flat) or rubbery feel (i.e., he/she feels the entire surface tacky as the surface of rubber) is strong, and, unlike natural leather, dry feel is not obtained, which leads to a sense of discomfort compared with natural leather.

In Japanese Patent Application Publication No. H08-060557, the finely napped surface formed using sandpaper or the like is excessively deformed due to, for example, contact with the hand, finger, or the like of a user, and therefore, the shape retainability resulting from pressure resistance and wear resistance is poor, and it is difficult to use it for a seating face that requires especially high pressure resistance and wear resistance, thus posing a problem in that the use application is limited.

Furthermore, there is also a problem in that friction between the leather surfaces increases due to the uneven pattern on the surfaces, and rubbing noise is likely to be produced.

In view of these circumstances, there is demand for synthetic resin leather that has good feel as natural leather, has excellent pressure resistance and wear resistance, and is capable of reducing rubbing noise between the surfaces of the skin layers.

In order to solve these problems, synthetic resin leather of the present invention includes: a base material; and a skin layer that is stacked on the base material and is made of a synthetic resin capable of being elastically deformed, wherein multiple micro recess parts are intermittently and regularly formed on a surface of the skin layer, and the multiple micro recess parts form multiple bottom face parts that are located at a substantially constant depth from the surface of the skin layer, and multiple inner side face parts that extend from the surface of the skin layer to the multiple bottom face parts and are capable of being elastically deformed.

Multiple ultramicro convex parts may be formed to provide a sandy texture on a portion of the surface of the skin layer other than the micro recess parts. In this case, an average height of the multiple ultramicro convex parts is smaller than the depths of the multiple micro recess parts.

Also, in order to solve these problems, a method for manufacturing synthetic resin leather of the present invention includes: a stacking process for forming a skin layer made of a synthetic resin capable of being elastically deformed on a base material; and an embossing process for intermittently and regularly forming multiple micro recess parts over an entire surface of the skin layer, wherein, in the embossing process, multiple bottom face parts that are located at a substantially constant depth from the surface of the skin layer, and multiple inner side face parts that extend from the surface of the skin layer to the multiple bottom face parts and are capable of being elastically deformed are embossed to form the multiple micro recess parts.

In the embossing process, multiple ultramicro convex parts may be formed to provide a sandy texture on a portion of the surface of the skin layer other than the micro recess parts. In this case, an average height of the multiple ultramicro convex parts is smaller than the depths of the multiple micro recess parts.

With the present invention, it is possible to provide synthetic resin leather that has good feel as natural leather, has excellent pressure resistance and wear resistance, and is capable of reducing rubbing noise between the surfaces of the skin layers. Also, it is possible to provide a method for manufacturing such synthetic resin leather.

### BRIEF DESCRIPTION OF THE DRAWINGS

FIG. 1 is a diagram showing the outline of a skin layer of synthetic resin leather of the present invention.

FIG. 2 is a partially enlarged longitudinal cross-sectional front view showing a relevant portion of an example of the synthetic resin leather of the present invention.

FIG. 3 is a partially enlarged longitudinal cross-sectional front view showing a relevant portion of another example of the synthetic resin leather of the present invention.

FIG. 4 is a partially enlarged longitudinal cross-sectional front view showing a relevant portion of yet another example of the synthetic resin leather of the present invention.

FIG. 5 is a partially enlarged longitudinal cross-sectional front view showing a relevant portion of yet another example of the synthetic resin leather of the present invention.

FIG. 6 is a reduced-size side view showing the overall structure of an example of a method for manufacturing synthetic resin leather of the present invention.

FIG. 7 at (a) is a partially enlarged longitudinal cross-sectional front view showing a relevant portion of yet another example of the synthetic resin leather of the present invention, and FIG. 7 at (b) is a conceptual drawing showing a state in which the surfaces of pieces of the synthetic resin leather shown in FIG. 7 at (a) are brought into contact and rubbed with each other.

FIG. 8 at (a) is a partially enlarged longitudinal cross-sectional front view showing a relevant portion of yet another example of the synthetic resin leather of the present invention, and FIG. 8 at (b) is a conceptual drawing showing a state in which the surfaces of pieces of the synthetic resin leather shown in FIG. 8 at (a) are brought into contact and rubbed with each other.

FIGS. 9 at (a) and 9 at (b) are explanatory diagrams showing an example of a micro recess part. FIG. 9 at (a) is an enlarged photograph showing the arrangement of the micro recess parts, and FIG. 9 at (b) is a further enlarged photograph.

### DESCRIPTION OF EMBODIMENTS

Hereinafter, embodiments of the present invention will be specifically described, but the present invention is not limited to these embodiments.

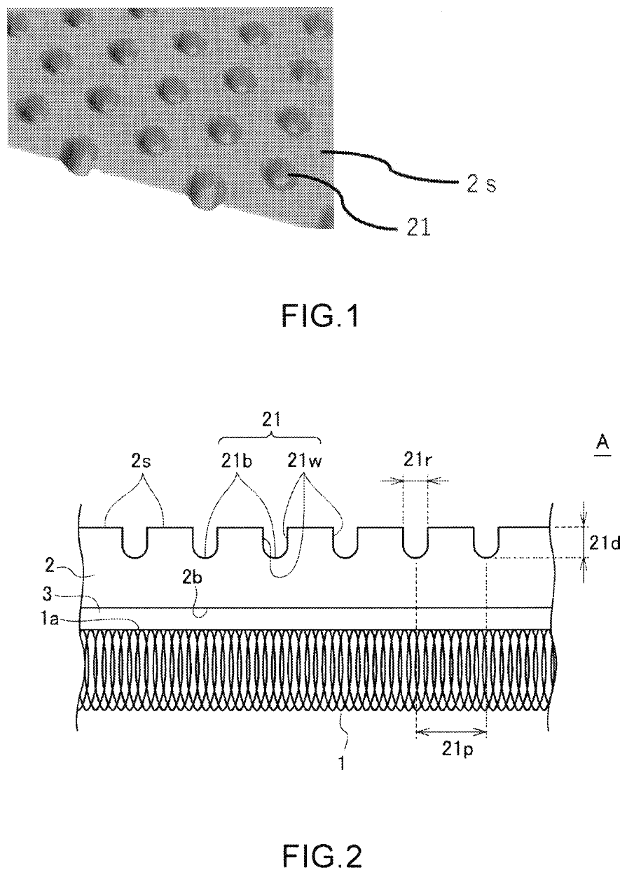

Synthetic resin leather A according to an embodiment of the present invention is one type of synthetic leather or artificial leather to be used as vehicle interior materials for automobiles and the like, upholstery for chairs, sofas, and the like, shoe upper materials, and skin materials for stationery (e.g., notebooks), smartphone cases, and the like. The synthetic resin leather A is one type of such synthetic leather and artificial leather and is obtained by forming a fine embossed pattern on a skin layer 2 provided on a base material 1 through embossing, as shown in FIG. 1 to FIGS. 9 at (a) and 9 at (b).

The synthetic resin leather A of the present invention includes the base material 1 and the skin layer 2.

The base material 1 is placed on the back side of the synthetic resin leather A and is made of cloth such as a woven or knitted fabric or nonwoven fabric, and it is preferable that the base material 1 imparts strength and appropriate thickness without loss of flexibility of the skin layer 2, which will be described later.

Examples of a material of the base material 1 include polyester fibers, rayon, polyvinyl chloride (PVC), fibers made of an olefin-based resin such as polypropylene, polyester fibers, polyamide fibers, acrylic fibers, cotton, rayon, and mixed yarn thereof.

It is also possible to use, as the base material 1, a soft foamed sheet or a stacked body formed by integrally stacking cloth and a soft foamed sheet.

It is preferable to form an underlayer 3 stacked on a front side surface 1a of the base material 1.

The underlayer 3 is an adhesive layer for bonding the front side surface 1a of the base material 1 to a back surface 2b of the skin layer 2, which will be described later, and is made of a polyvinyl chloride paste, an ethylene-vinyl acetate copolymer-based emulsion, a two-component polyurethane adhesive, or the like.

Furthermore, it is preferable that the underlayer 3 is stacked between the front side surface 1a of the base material 1 and the back surface 2b of the skin layer 2 by applying an adhesive on the front side surface 1a of the base material 1 or applying an adhesive on the back surface 2b of the skin layer 2.

In addition, in another example, it is also possible to provide a soft foamed sheet made of a polypropylene foam or the like (not illustrated) between the front side surface 1a of the base material 1 and the back surface 2b of the skin layer 2.

The skin layer 2 is arranged on the front side of the synthetic resin leather A, and is made of a low-hardness thermoplastic resin that is capable of being elastically deformed and is flexible, such as soft polyvinyl chloride (PVC), thermoplastic polyurethane, a soft acrylic resin, copolymerized polyester, or a partially cross-linked polyolefin elastomer, and it is particularly preferable that the skin layer 2 contains soft polyvinyl chloride as the main component.

The thickness of the skin layer 2 is 0.3 mm to 0.6 mm and preferably 0.3 mm to 0.4 mm, and a depth 21d from a surface 2s of the skin layer 2 to a bottom face part 21b is smaller than the thickness of the skin layer 2.

Multiple micro recess parts 21 are intermittently (non-continuously) formed in a state of being separated from each other on the surface 2s of the skin layer 2, and are regularly arranged along the surface 2s of the skin layer 2.

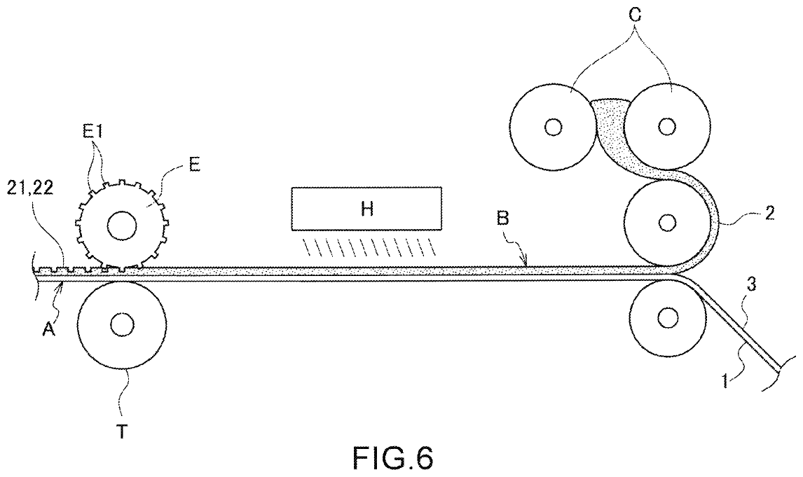

The micro recess parts 21 are micron-size microdots that are embossed over the entire surface 2s of the skin layer 2 through embossing performed using an embossing block. As illustrated in FIG. 6, it is preferable to use an embossing roller E as the embossing block, and the surface of the embossing roller E that is opposed to the surface 2s of the skin layer 2 is engraved with an embossed pattern E1 by using one processing step or a combination of two or more processing steps selected from the group consisting of laser processing, etching, milling, sandblasting, and the like. As the embossed pattern E1, at least multiple fine convex parts (schematically illustrated) corresponding to the multiple micro recess parts 21 are intermittently and regularly provided over the substantially entire surface of the roller. It is also possible to further engrave the surface of the roller with recess parts and convex parts for forming a pattern such as a specific pattern as another embossed pattern E1 (not illustrated).

Furthermore, each of the micro recess parts 21 includes a bottom face part 21b located at a substantially constant depth 21d from the surface 2s of the skin layer 2, and an inner side face part 21w that extends from the surface 2s of the skin layer 2 to the bottom face part 21b and is capable of being elastically deformed.

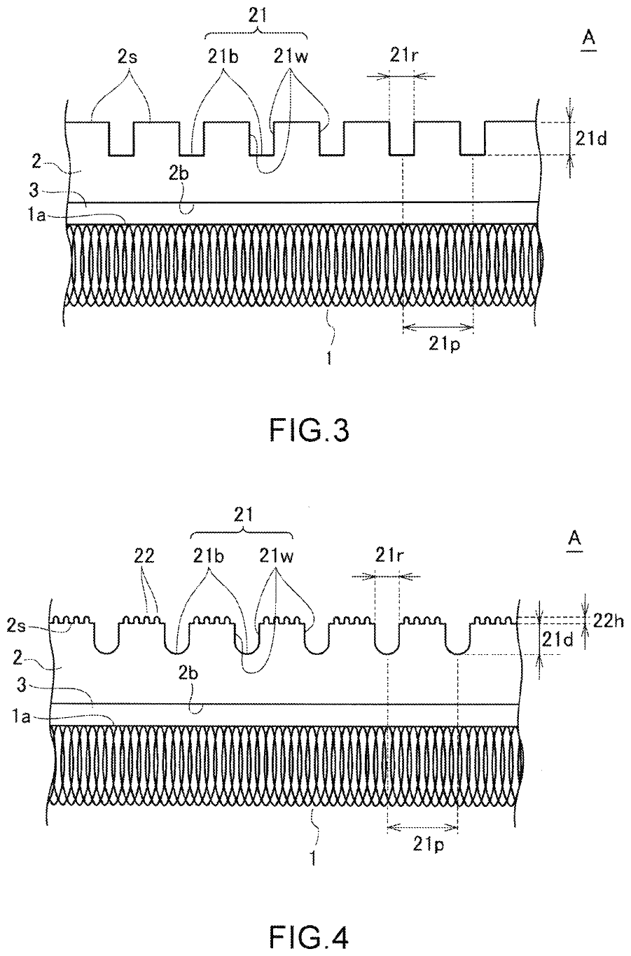

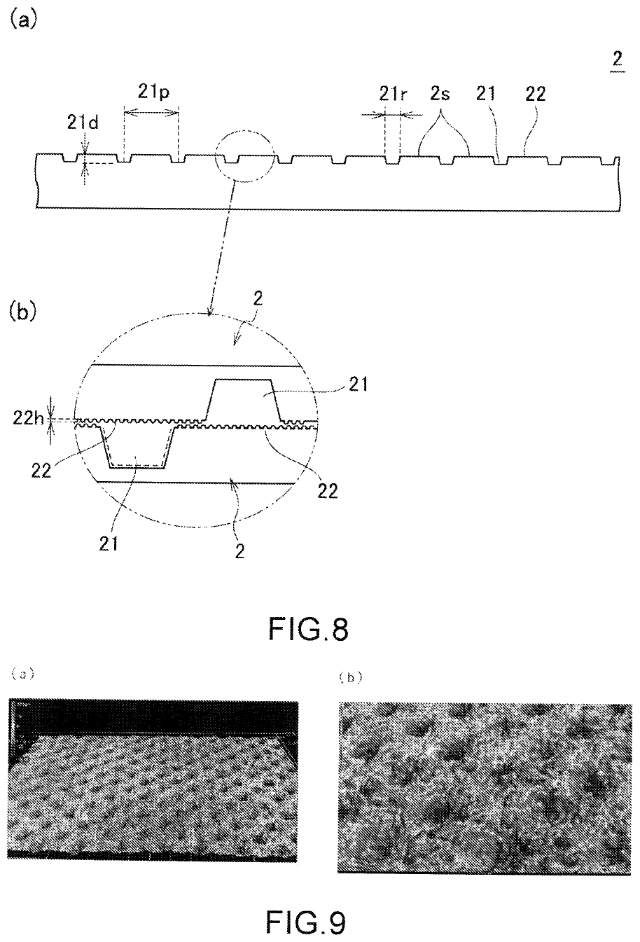

The micro recess part 21 is formed in a substantially cylindrical shape with a flat bottom face part, or a hemispherical shape (helmet shape) with a curved bottom face part. When the micro recess part 21 has a substantially cylindrical shape, the bottom face part 21b is flat as shown in FIG. 3, and when the micro recess part 21 has a hemispherical shape, the bottom face part 21b has a curved shape as shown in FIGS. 1, 2, 4, 7 at (a), 7 at (b), 9 at (a) and 9 at (b). In addition, the micro recess part 21 may be formed in a substantially prism shape by shaping the hole in the surface 2s of the skin layer 2 in a polygonal shape, or may be formed in a truncated cone shape as shown in FIGS. 8 at (a) and 8 at (b).

Since the sizes of the multiple micro recess parts 21 are in the order of microns, it is difficult to confirm whether or not the micro recess parts 21 are present with the naked eye, and the micro recess parts 21 can be seen only when magnified using a microscope or the like as shown in FIGS. 9 at (a) and 9 at (b). In the three-dimensional image as shown in FIG. 9 at (a) obtained by the 3D display function of a digital microscope such as a 3D measurement laser microscope, X-axis and Y-axis scales with a pitch of 50 μm are displayed in order to confirm the sizes of the multiple micro recess parts 21, and the height color display for indicating a difference in height is employed. Furthermore, in FIG. 9 at (b), a part of the image is enlarged such that the more detailed structures of the multiple micro recess parts 21 can be read. Note that, in FIGS. 9 at (a) and 9 at (b), the three-dimensional images are shown in grayscale.

Furthermore, multiple ultramicro convex parts 22 may be formed to provide a sandy texture on a portion of the surface 2s of the skin layer 2 other than the micro recess parts 21, and be regularly arranged along the surface 2s of the skin layer 2.

The ultramicro convex parts 22 are micron-size microdots embossed on a portion of the surface 2s of the skin layer 2 other than the micro recess parts 21 through embossing performed using an embossing block. As illustrated in FIG. 6, it is preferable to use an embossing roller E as the embossing block, and the surface of the embossing roller E that is opposed to the surface 2s of the skin layer 2 is engraved with an embossed pattern E1 by using one processing step or a combination of two or more processing steps selected from the group consisting of laser processing, etching, milling, sandblasting, and the like. As the embossed pattern E1, at least multiple ultrafine recess parts (not illustrated) corresponding to the multiple ultramicro convex parts 22 are provided on the surface of the roller. It is preferable that the multiple ultrafine recess parts corresponding to the multiple ultramicro convex parts 22 are provided on the surface of the embossing block for the embossed pattern E1 together with the multiple fine convex parts corresponding to the multiple micro recess parts 21 described above. It is also possible to further engrave the surface of the roller with recess parts and convex parts for forming a pattern such as a specific pattern as another embossed pattern E1 (not illustrated).

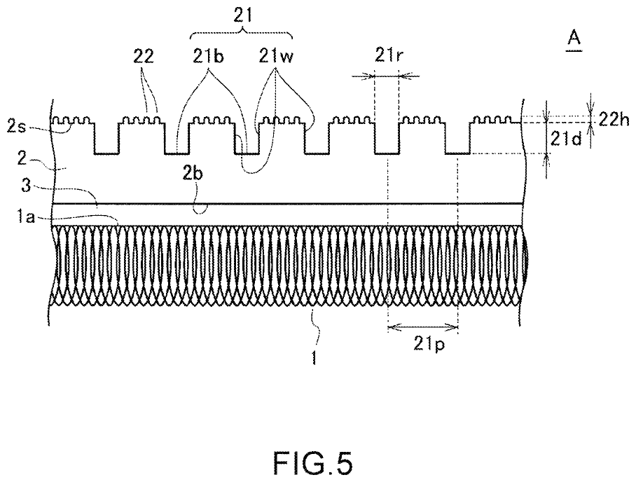

As illustrated in FIGS. 4 and 5, it is preferable that the multiple ultramicro convex parts 22 are formed on the surface 2s of the skin layer 2 with an average height 22h. Also, the average height 22h of the multiple ultramicro convex parts 22 is smaller than the depths 21d of the multiple micro recess parts 21.

In order to simultaneously obtain good dry feel as natural leather and excellent pressure resistance and wear resistance, an inner diameter 21r of each of the multiple micro recess parts 21, the depth 21d thereof, and an interval 21p between the adjacent micro recess parts 21 have to be set to be in predetermined size balance. Furthermore, when the ultramicro convex parts 22 are formed, the height 22h of the ultramicro convex parts 22 is taken into consideration, and the height 22h, the inner diameter 21r and depth 21d of the micro recess parts 21, and the interval 21p between the micro recess parts 21 have to be set to be in predetermined size balance.

The inner diameter 21r (size, average diameter) of the micro recess parts 21 corresponds to the average diameter 21r of the inner side face parts 21w on the surface 2s side of the skin layer 2. The depth 21d of each micro recess part 21 corresponds to the average depth 21d obtained from the depths from the surface 2s of the skin layer 2 to the bottom face parts 21b. The interval 21p between the adjacent micro recess parts 21 corresponds to the average interval 21p obtained from the intervals between the centers of the adjacent inner side face parts 21w. The height 22h of the ultramicro convex part 22 constituting the sandy texture on the surface 2s corresponds to the average height 22h obtained from the heights of the ultramicro convex parts 22 from the surface 2s to the apexes.

The inner diameter 21r (size, average diameter) of the micro recess parts 21 is set to be 40 μm to 110 μm, preferably 60 μm to 100 μm, and more preferably 65 μm to 75 μm. If the interval 21p between the micro recess parts 21 and the average depth 21d of the micro recess parts 21 are constant, and the average inner diameter 21r of the micro recess parts 21 is reduced to, for example, smaller than 40 μm, the surface 2s and the inner side face parts 21w relatively have increased areas, and thus elastic deformation is not likely to occur. On the other hand, if the interval 21p between the micro recess parts 21 and the average depth 21d of the micro recess parts 21 are constant, and the average diameter 21r of the micro recess parts 21 is increased to, for example, larger than 110 μm, the surface 2s and the inner side face parts 21w relatively have excessively reduced areas, and thus elastic deformation or collapsing deformation are likely to occur more than necessary.

The depth 21d (average depth) of the micro recess parts 21 is set to be 30 μm to 100 μm, preferably 40 μm to 80 μm, and more preferably 60 μm to 70 μm. If the interval 21p between the micro recess parts 21 and the inner diameters 21r of the micro recess parts 21 are constant, and the average depth 21d of the micro recess parts 21 is reduced to, for example, smaller than 30 μm, the distance from the surface 2s to the bottom face parts 21b is small (shallow), and the micro recess parts 21 relatively have an excessively large diameter and an excessively small depth. Thus, the bottom face parts 21b extremely come close to the surface 2s of the skin layer 2, and the inner side face parts 21w are not likely to be elastically deformed. On the other hand, if the interval 21p between the micro recess parts 21 and the inner diameters 21r of the micro recess parts 21 are constant, and the average depth 21d of the micro recess parts 21 is increased to, for example, larger than 100 μm, the distance from the surface 2s to the bottom face parts 21b are large, and the micro recess parts 21 relatively have excessively small diameter and an excessively large depth. Thus, bending deformation of the inner side face parts 21w is likely to occur due to a load.

The interval 21p between the adjacent micro recess parts 21 (average interval between the centers) is set to be 180 μm to 310 μm, preferably 190 μm to 280 μm, and more preferably 195 μm to 210 μm. If the inner diameters 21r and the depths 21d of the micro recess parts 21 are constant, and the average interval 21p between the centers of the micro recess parts 21 is reduced to, for example, smaller than 180 μm, the micro recess parts 21 come excessively close to each other, and the density of the micro recess parts 21 relative to the surface 2s of the skin layer 2 is increased. Thus, when the hand, finger, or the like of a user comes into contact with the surface 2s of the skin layer 2, the inner side face parts 21w are likely to be elastically deformed, and big rubbing noise is produced. On the other hand, if the inner diameters 21r and the depths 21d of the micro recess parts 21 are constant, and the average interval 21p between the centers of the micro recess parts 21 is increased to, for example, larger than 310 μm, the bottom face parts 21b are excessively away from each other, and the inner side face parts 21w are also excessively away from each other. Thus, the density of the micro recess parts 21 relative to the surface 2s of the skin layer 2 is reduced, and therefore, when the hand, finger, or the like of a user comes into contact with the surface 2s of the skin layer 2, the inner side face parts 21w are not likely to be elastically deformed.

Although the sizes of the inner diameter 21r (size, average diameter) and the depth 21d (average depth) of the micro recess parts 21, and the interval 21p between the micro recess parts 21 (average interval between the centers) have been described in relation to elastic deformation one by one, it is desirable that good balance therebetween is achieved because the inner diameter 21r, the depth 21d, and the interval 21p are relatively related to each other.

That is to say, it is preferable to employ the size balance where the average ratio between the inner diameter 21r (size, average diameter) of each of the multiple micro recess parts 21, the depth 21d (average depth) thereof, and the interval 21p between the micro recess parts 21 (average interval between the centers) is “inner diameter 21r:depth 21d: interval 21p” as described below, and the interval 21p is larger than the inner diameter 21r.
“inner diameter 21r:depth 21d: interval 21p=40 μm to 110 μm: 30 μm to 100 μm: 180 μm to 310 μm=about 2.0 to 5.5: about 1.5 to 5.0: about 9.0 to 15.5”

Furthermore, when the ultramicro convex parts 22 are formed, the heights 22h (average height) of the ultramicro convex parts 22 constituting the sandy texture are approximately 5.0 μm to 12.5 μm, the outer diameters and the intervals are set to be small and random so as to form the sandy texture, and an average surface roughness Ra is approximately 1.0 μm to 2.6 μm, in an example.

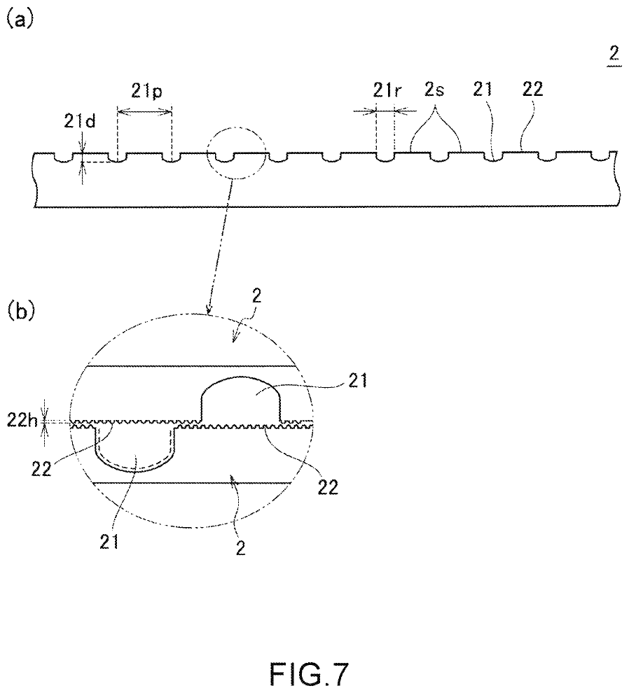

The surface 2s of the skin layer 2 has a three-dimensional structure due to the multiple micro recess parts 21, and since the skin layer 2 is provided with the multiple micro recess parts 21, friction produced between the skin layers 2 that are rubbed with each other is small, and rubbing noise can be reduced, compared with the case where multiple protrusions that have the same size as that of the micro recess parts 21 of the present invention and that are located with the same interval as the interval between the micro recess parts 21 of the present invention protrude from the surface of the skin layer (see FIGS. 7 at (a) and 7 at (b), and FIGS. 8 at (a) and 8 at (b)).

Next, a specific example of the synthetic resin leather A according to an embodiment of the present invention will be described.

FIG. 1 schematically shows the skin layer 2 of the synthetic resin leather A. The surface 2s of the skin layer 2 is provided with the micro recess parts 21.

In the synthetic resin leather A illustrated in FIG. 2, only the multiple micro recess parts 21 are regularly arranged on the surface 2s of the skin layer 2 at predetermined or regular intervals in a staggered configuration through embossing performed using multiple fine convex parts that are engraved as the embossed pattern E1 on the embossing roller E. The bottom face parts 21b of the micro recess parts 21 are curved. Note that FIG. 2 is a partially enlarged view showing the vicinity of the surface 2s of the skin layer 2, which is a relevant portion.

In the synthetic resin leather A illustrated in FIG. 3, only the multiple micro recess parts 21 are regularly arranged on the surface 2s of the skin layer 2 at predetermined or regular intervals in a staggered configuration through embossing performed using multiple fine convex parts that are engraved as the embossed pattern E1 on the embossing roller E. The bottom face parts 21b of the micro recess parts 21 are flat. Note that FIG. 3 is a partially enlarged view showing the vicinity of the surface 2s of the skin layer 2, which is a relevant portion.

In the synthetic resin leather A illustrated in FIG. 4, the multiple micro recess parts 21 and multiple ultramicro convex parts 22 are arranged on the surface 2s of the skin layer 2 through embossing performed using multiple fine convex parts and ultrafine recess parts that are engraved as the embossed pattern E1 on the embossing roller E. The bottom face parts 21b of the micro recess parts 21 are curved.

In the synthetic resin leather A illustrated in FIG. 5, the multiple micro recess parts 21 and multiple ultramicro convex parts 22 are arranged on the surface 2s of the skin layer 2 through embossing performed using multiple fine convex parts and ultrafine recess parts that are engraved as the embossed pattern E1 on the embossing roller E. The bottom face parts 21b of the micro recess parts 21 are flat.

The multiple micro recess parts 21 and the multiple ultramicro convex parts 22 are arranged on the skin layer 2 of the synthetic resin leather A illustrated in FIG. 7 at (a), and the bottom face parts 21b of the micro recess parts 21 are curved.

FIG. 7 at (b) is an enlarged conceptual drawing showing a state in which the skin layers 2 of pieces of the synthetic resin leather A shown in FIG. 7 at (a) are brought into contact and rubbed with each other. Since the micro recess parts 21 are formed as “recesses” on the surface 2s, the micro recess parts 21 are not likely to be engaged with each other, thus making it possible to reduce generation of unusual noise. On the other hand, the ultramicro convex parts 22 are formed as “ultrafine dots constituting the sandy texture” on a portion of the surface 2s of the skin layer 2 in which the skin layer 2 comes into direct contact with a hand or another skin layer 2, thus making it possible to obtain even better feel.

The multiple micro recess parts 21 and the multiple ultramicro convex parts 22 are arranged on the skin layer 2 of the synthetic resin leather A illustrated in FIG. 8 at (a), and the bottom face parts 21b of the micro recess parts 21 are flat.

FIG. 8 at (b) is an enlarged conceptual drawing showing a state in which the skin layers 2 of pieces of the synthetic resin leather A shown in FIG. 8 at (a) are brought into contact and rubbed with each other. Since the micro recess parts 21 are formed as “recesses” on the surface 2s, the micro recess parts 21 are not likely to be engaged with each other, thus making it possible to reduce generation of unusual noise. On the other hand, the ultramicro convex parts 22 are formed as “ultrafine dots constituting the sandy texture” on a portion of the surface 2s of the skin layer 2 in which the skin layer 2 comes into direct contact with a hand or another skin layer 2, thus making it possible to obtain even better feel.

In other examples (not illustrated), modifications can be made to, for example, arrange the multiple micro recess parts 21 at predetermined or regular intervals in a lattice (grid) configuration.

Furthermore, if necessary, it is also possible to, for example, adjust excellent wear resistance or gloss by forming, on the surface 2s of the skin layer 2, a surface treated layer (not illustrated) that covers the multiple micro recess parts 21 and the multiple ultramicro convex parts 22. A urethane resin, an acrylic resin, or the like is used as the material of the surface treated layer, and are applied onto the surface 2s of the skin layer 2 at a constant thickness to form the surface treated layer. The thickness of the surface treated layer is 1 μm to 30 μm, and preferably 10 μm to 20 μm.

### Manufacturing Method

As illustrated in FIG. 6, a method for manufacturing the synthetic resin leather A of the present invention includes: a stacking process for forming the skin layer 2 made of a synthetic resin capable of being elastically deformed on the base material 1; and an embossing process for intermittently and regularly forming multiple micro recess parts 21 over the entire surface 2s of the skin layer 2.

In the stacking process, the back surface 2b of the skin layer 2 is directly bonded to, or is bonded via the underlayer 3 to, the front side surface 1a of the base material 1 through calender molding, extrusion molding, or the like.

In the embossing process, the multiple micro recess parts 21 and the like are intermittently and regularly provided over the entire surface 2s of the skin layer 2 by performing, for example, embossing on the surface 2s using the embossing roller E.

In addition, when the surface treated layer that covers the multiple micro recess parts 21 is formed on the surface 2s of the skin layer 2, it is preferable to apply a material of the surface treated layer such as a urethane resin onto the surface 2s of the skin layer 2 at least prior to the embossing process.

In FIG. 6 showing the specific example of the method for manufacturing the synthetic resin leather A, the embossing process is performed after the stacking process.

The front side surface 1a of the base material 1 is stacked, via the underlayer 3, on the back surface 2b of the skin layer 2 that has been rolled to a predetermined thickness using a calender molding machine C, and the front surface side of a stacked body B is heated using a heater H. Subsequently, the stacked body B is sandwiched between the embossing roller E and a touch roller T, and the multiple micro recess parts 21 are transferred to the surface 2s of the skin layer 2.

This is preferable because the overall thickness is increased due to the addition of the thicknesses of the underlayer 3 and the base material 1 to the thickness of the skin layer 2 in the stacking process performed previously, and thus the depth of the embossed pattern (multiple micro recess parts 21) transferred from the embossing roller E can be increased.

In other examples (not illustrated), modifications can be made, for example, to separately perform the rolling of the skin layer 2 using the calender molding machine C and the stacking of the base material 1 via the underlayer 3, to perform the stacking of the base material 1 via the underlayer 3 after the transfer of the multiple micro recess parts 21 to the surface 2s of the skin layer 2, and the like.

In addition, when the surface treated layer is formed to obtain excellent wear resistance, the transfer may be performed by forming the surface treated layer on the surface of the stacked body B and then heating the surface treated layer using the heater H, and sandwiching the stacked body B between the embossing roller E and the touch roller T. The formation of the surface treated layer can be modified, and may be performed, for example, simultaneously with or separately from the embossing process.

With this synthetic resin leather A of the present invention and the method for manufacturing the same, when a user touches, with his/her hand, finger, or the like, the surface 2s of the skin layer 2 having the multiple micro recess parts 21 that are intermittently and regularly provided over the entire surface 2s of the skin layer 2 capable of being elastically deformed, some inner side face parts 21w are elastically deformed due to the contact with the hand, finger, or the like, and thus the surface 2s moves (slightly moves). Subsequently, when the hand, finger, or the like is moved away from the surface 2s, the inner side face parts 21w that have been elastically deformed due to the contact and the surface 2s that have moved (slightly moved) return to the original shapes. For this reason, the surface 2s of the skin layer 2 is three-dimensional as a whole due to the multiple micro recess parts 21 capable of slightly moving, is not tacky, and can be finished to dry feel to the extent as natural leather. In addition, even if such contact with the hand, finger, or the like is repeated, the elastic deformation of the inner side face parts 21w and the movement (slight movement) of the bottom face parts 21b are repeated without difficulty, and thus plastic deformation is not likely to occur.

Accordingly, it is possible to provide the synthetic resin leather A having good dry feel as natural leather and excellent pressure resistance.

As a result, compared with conventional one with an embossed pattern that is formed through embossing and in which recess parts and convex parts are incapable of being elastically deformed and are continuously arranged, flat feel (i.e., a user feels the entire surface flat) and rubbery feel (i.e., a user feels the entire surface tacky as the surface of rubber) are lost, and good moist soft feel as a suede-like fabric (upholstery for chairs, sofas, and the like) or the like can be obtained. Also, compared with conventional one having a finely napped surface formed using sandpaper or the like, excessive deformation is not caused by, for example, contact with the hand, finger, or the like of a user, thus making it possible to use the synthetic resin leather A for a seating face that requires especially high pressure resistance.

Accordingly, the synthetic resin leather A can be improved in quality, does not produce a sense of discomfort compared with natural leather, can be used as an alternative to natural leather in many fields, and is of excellent convenience.

In particular, it is preferable that the multiple micro recess parts 21 are formed in a hemispherical shape as shown in FIGS. 2, 4, 7 at (a), and 7 at (b) with the multiple bottom face parts 21b being curved, or formed in a substantially cylindrical shape as shown in FIGS. 3 and 5 with the multiple bottom face parts 21b being flat, or formed in a truncated cone shape as shown in FIGS. 8 at (a) and 8 at (b).

When the bottom face parts 21b are curved or flat, local plastic deformation is more unlikely to occur even when contact with a hand, finger, or the like is repeated, compared with the bottom face parts 21b have a point-like shape.

Therefore, the pressure resistance of the multiple micro recess parts 21 and the bottom face parts 21b can be further improved.

As a result, deterioration caused by long-term use can be prevented. This makes it possible to extend the product life and reduce costs.

Furthermore, it is preferable that the inner diameter 21r (average inner diameter) of each of the multiple micro recess parts 21, the depth 21d (average depth) thereof, the interval 21p between the micro recess parts 21 (average interval between the centers), and the average ratio therebetween are set to “40 μm to 110 μm (about 2.0 to 5.5): 30 μm to 100 μm (about 1.5 to 5.0): 180 μm to 310 μm (about 9.0 to 15.5)”, and the interval 21p is larger than the inner diameter 21r (more preferably approximately twice).

This balance of arrangement makes it possible to smooth the elastic deformation of the inner side face parts 21w and the movement (slight movement) of the bottom face parts 21b caused by contact of the multiple micro recess parts 21 with the hand, finger, or the like of a user, and the recovering deformation of the inner side face parts 21w and the recovering slight movement of the bottom face parts 21b caused by moving the hand, finger, or the like away from the multiple micro recess parts 21.

Accordingly, it is possible to reliably achieve good dry feel as natural leather and excellent pressure resistance.

The surface 2s of the skin layer 2 has a three-dimensional structure due to the multiple micro recess parts 21, and since the skin layer 2 is provided with the multiple micro recess parts 21, friction produced between the skin layers 2 that are rubbed with each other is small, and rubbing noise can be reduced, compared with the case where multiple protrusions that have the same size as that of the micro recess parts 21 of the present invention and that are located with the same interval as the interval between the micro recess parts 21 of the present invention protrude from the surface of the skin layer.

In the embossing process, multiple ultramicro convex parts 22 may be further formed to provide a sandy texture on a portion of the surface 2s of the skin layer 2 other than the micro recess parts 21. The multiple ultramicro convex parts 22 are formed such that the average height from the surface 2s of the skin layer 2 is an average height 22h. Also, the average height 22h of the multiple ultramicro convex parts 22 is smaller than the depths 21d of the multiple micro recess parts 21.

When the ultramicro convex parts 22 are formed, the height 22h (average height) of the ultramicro convex parts 22 constituting the sandy texture is approximately 5.0 μm to 12.5 μm, the outer diameters and the intervals are set to be small and random so as to form the sandy texture, and an average surface roughness Ra is approximately 1.0 μm to 2.6 μm, in an example.

When multiple ultramicro convex parts 22 are provided together, the embossing process can be performed using multiple fine convex parts and ultrafine recess parts engraved as the embossed pattern E1 on the embossing roller E, in an example.

Without further elaboration, it is believed that one skilled in the art can, using the preceding description, utilize the present invention to its fullest extent. The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated.

The entire disclosures of all applications, patents and publications, cited herein and of corresponding Japanese application No. 2023-064072, filed Apr. 11, 2023, are incorporated by reference herein.

### EXAMPLES

Hereinafter, examples of the present invention will be described.

### Examples 1 to 9 and Comparative Examples 1 to 9

Synthetic resin leather of Examples 1 to 9 shown in Table 1 and synthetic resin leather of Comparative Examples 1 to 9 shown in Table 2 were produced by transferring multiple micro recess parts to the surface of the skin layer containing soft polyvinyl chloride as a main component through embossing performed using embossing blocks (embossing rollers) produced by engraving multiple fine recess parts and convex parts corresponding to micro recess parts having inner diameters (average diameters), depths (average depths), and intervals (average intervals between the centers) listed in the tables and ultramicro convex parts having heights (average heights) listed in the tables and constituting the sandy texture. In evaluation samples produced therefrom, the skin layer had a thickness of 0.4 mm, and the total thickness of the skin layer, underlayer, and the base material was 1.1 mm.

Examples 1 to 9 and Comparative Examples 1 to 7 had a common configuration in which multiple cylindrical micro recess parts each having a flat bottom face part were intermittently and regularly (at regular intervals in a staggered configuration) arranged and the front side surface of the base material was stacked on the back surface of the skin layer via the underlayer, as shown in FIGS. 3 and 5. Comparative Example 8 differed from Examples 1 to 9 and Comparative Examples 1 to 7 in that multiple micro recess parts were arranged in an irregular (random) manner. In Comparative Example 9, micro convex parts (micro protrusions) were arranged instead of the micro recess parts.

In addition, evaluation samples of Examples 1 to 9 and Comparative Examples 1 to 9 in which the surface treated layer was formed on the surface of the skin layer to cover the multiple micro recess parts were produced.

In Examples 1 to 9, the micro recess parts had an inner diameter (average inner diameter) of 40 μm to 110 μm and a depth (average depth) of 30 μm to 100 μm, the intervals between the micro recess parts (average interval between the centers) were 180 μm to 310 μm, and the skin layer had a thickness of 0.4 mm. In Examples 1 to 8, the ultramicro convex parts constituting the sandy texture were provided, and they had a height (average height) of 5 μm to 12 μm. In Example 9, the ultramicro convex parts were not provided.

In Example 1, the micro recess parts had an average inner diameter of 50 μm and an average depth of 60 μm, the average interval between the centers was 200 μm, and the ultramicro convex parts constituting the sandy texture had an average height of 8 μm.

In Example 2, the micro recess parts had an average inner diameter of 110 μm and an average depth of 60 μm, the average interval between the centers was 200 μm, and the ultramicro convex parts constituting the sandy texture had an average height of 8 μm.

In Example 3, the micro recess parts had an average inner diameter of 70 μm and an average depth of 30 μm, the average interval between the centers was 200 μm, and the ultramicro convex parts constituting the sandy texture had an average height of 8 μm.

In Example 4, the micro recess parts had an average inner diameter of 70 μm and an average depth of 100 μm, the average interval between the centers was 200 μm, and the ultramicro convex parts constituting the sandy texture had an average height of 8 μm.

In Example 5, the micro recess parts had an average inner diameter of 70 μm and an average depth of 60 μm, the average interval between the centers was 180 μm, and the ultramicro convex parts constituting the sandy texture had an average height of 8 μm.

In Example 6, the micro recess parts had an average inner diameter of 70 μm and an average depth of 60 μm, the average interval between the centers was 310 μm, and the ultramicro convex parts constituting the sandy texture had an average height of 8 μm.

In Example 7, the micro recess parts had an average inner diameter of 70 μm and an average depth of 60 μm, the average interval between the centers was 200 μm, and the ultramicro convex parts constituting the sandy texture had an average height of 5 μm.

In Example 8, the micro recess parts had an average inner diameter of 70 μm and an average depth of 60 μm, the average interval between the centers was 200 μm, and the ultramicro convex parts constituting the sandy texture had an average height of 12 μm.

In Example 9, the micro recess parts had an average inner diameter of 70 μm and an average depth of 60 μm, the average interval between the centers was 200 μm, and the ultramicro convex parts constituting the sandy texture were not provided.

On the other hand, in Comparative Examples 1 to 9, any of the average inner diameter, the average depth, and the average interval between the centers was out of the ranges of those of the micro recess parts of Examples 1 to 9.

Comparative Example 1 was the same as Examples 1 and 2, except that the micro recess parts had an average inner diameter of 30 μm.

Comparative Example 2 was the same as Examples 1 and 2, except that the micro recess parts had an average inner diameter of 130 μm.

Comparative Example 3 was the same as Examples 3 and 4, except that the micro recess parts had an average depth of 15 μm.

Comparative Example 4 was the same as Examples 3 and 4, except that the micro recess parts had an average depth of 120 μm.

Comparative Example 5 was the same as Examples 5 and 6, except that the average interval between the centers of the micro recess parts was 150 μm.

Comparative Example 6 was the same as Examples 5 and 6, except that the average interval between the centers of the micro recess parts was 330 μm.

Comparative Example 7 was the same as Examples 7 and 8, except that the ultramicro convex parts constituting the sandy texture had an average height of 20 μm.

In Comparative Example 8, the micro recess parts had an average inner diameter of 70 μm and an average depth of 60 μm, and the average interval between the centers was 200 μm, but the micro recess parts were arranged in a random manner, not in a regular manner.

In Comparative Example 9, micro protrusions were provided instead of the micro recess parts, and in this structure, the micro protrusions protruded such that the micro protrusions and the micro recess parts of the examples were symmetrical with respect to the surface 2s of the skin layer 2.

### Evaluation Criteria

The evaluation results (feel, pressure resistance, wear resistance, rubbing noise) shown in Tables 1 and 2 are based on the following indicators.

In Examples 1 to 9 and Comparative Examples 1 to 9, the “Feel” was evaluated by a test to confirm the texture of the surface. The feel at the time of being touched by a finger was tested, and the test results were evaluated according to five levels.

The evaluation results of the “Feel” of the surface of the sample at the time of being touched by a finger were as follows: the surface that felt dry as the surface of natural leather was determined as “Dry”; the surface that was in an intermediate state between a dry state and a smooth state where the surface felt a little more flatter than the surface of natural leather was determined as “Dry-Smooth”; the surface that was smooth and felt more flatter than the surface of natural leather was determined as “Smooth”; the surface with a sandy texture that felt rough was determined as “Rough”; and the surface that felt sandier and rougher than the surface of the natural leather was determined as “Very Rough”.

In Examples 1 to 9 and Comparative Examples 1 to 9, the “Pressure resistance” was evaluated by a test to confirm whether or not the micro recess parts deteriorated (the micro recess parts had restorability). A flat iron plate with a size of 30 cm×30 cm was placed on each of the evaluation samples, and was left to stand for 30 minutes with a load of 60.0 kg being evenly applied. Then, the iron plate and the load were removed, and the surface condition was confirmed 5 minutes after. The test results were evaluated according to three levels.

The evaluation results of the “Pressure resistance” were as follows: if the micro recess parts did not deteriorate at all, the pressure resistance was determined as “Excellent”; if the micro recess parts barely deteriorated, the pressure resistance was determined as “Good”; and if the micro recess parts deteriorated, the pressure resistance was determined as “Poor”.

In the case where the surface treated layer was formed on the surface of the skin layer in Examples 1 to 9 and Comparative Examples 1 to 9, the “Wear resistance” was evaluated by a test to confirm whether or not the surface of the skin layer and the micro recess parts were worn (shaven off). The friction test was conducted by reciprocating a cotton canvas No. 6 according to JIS L3102 30,000 times with a load of 1.0 kg being applied thereto using a Gakushin-type friction testing machine prescribed in JIS L 0823 (Apparatus for Testing of Colour Fastness to Rubbing). Note that a urethane foam with a width of 10 mm and a thickness of 4 mm was bonded to each of the evaluation samples to which the surface treatment agent had been applied, and the resultant products were used. The test results were evaluated according to three levels. The evaluation results of the “Wear resistance” were as follows: if the wear was inconspicuous after 30,000-times reciprocation, the wear resistance was determined as “Excellent”; if the wear was observed after 20,000-times reciprocation, the wear resistance was determined as “Poor”; and if the skin layer was broken after 20,000-times reciprocation, the wear resistance was determined as “Broke”.

The “Rubbing noise” was evaluated based on a Stick-Slip test conducted using stacked skin layers, and the sound. The rubbing noise was evaluated according to four levels based on the standard deviation of a kinetic friction force and the sound generated when the skin layers were rubbed with each other by hand.

The rubbing noise was evaluated as follows: “4: no sound was heard”, “3: sound was barely heard”, “2: sound was slightly heard”, and “1: sound was heard”.

The “Overall evaluation” was based on the evaluation results of the above-described “Feel”, “Pressure resistance”, “Wear resistance”, and “Rubbing noise”, and was determined by collectively evaluating these results according to three levels.

The evaluation results of the “Overall evaluation” were as follows: if all of the feel, the pressure resistance, the wear resistance, and the rubbing noise were excellent, the sample was determined as “Optimum”; if any of the feel, the pressure resistance, and the wear resistance was slightly poor but was within tolerable limits, the sample was determined as “Favorable”; and if any of the feel, the pressure resistance, and the wear resistance was poor and was out of tolerable limits, the sample was determined as “Unsuitable”.

TABLE 1

| | | Example 1 | Example 2 | Example 3 | Example 4 | Example 5 | Example 6 | Example 7 | Example 8 | Example 9 |
|---|---|---|---|---|---|---|---|---|---|---|
| Micro | Inner diameter (μm) | 50 | 110 | 70 | 70 | 70 | 70 | 70 | 70 | 70 |
| recess part | Depth (μm) | 60 | 60 | 30 | 100 | 60 | 60 | 60 | 60 | 60 |
| | Interval (μm) | 200 | 200 | 200 | 200 | 180 | 310 | 200 | 200 | 200 |
| | Arrangement | Regular | Regular | Regular | Regular | Regular | Regular | Regular | Regular | Regular |
| | Unevenness | Micro | Micro | Micro | Micro | Micro | Micro | Micro | Micro | Micro |
| | | recess | recess | recess | recess | recess | recess | recess | recess | recess |
| Ultramicro | Height (μm) | 8 | 8 | 8 | 8 | 8 | 8 | 5 | 12 | None |
| convex part | | | | | | | | | | |
| Evaluation | Feel | Dry | Dry | Dry | Dry | Dry | Dry | Dry | Dry | Smooth-Dry |
| result | Pressure resistance | Excellent | Excellent | Excellent | Excellent | Excellent | Excellent | Excellent | Excellent | Excellent |
| | Wear resistance | Excellent | Excellent | Excellent | Excellent | Excellent | Excellent | Excellent | Excellent | Excellent |
| | Rubbing noise | 3 | 3 | 4 | 4 | 4 | 4 | 4 | 4 | 4 |
| | Overall evaluation | Favorable | Favorable | Optimum | Optimum | Optimum | Optimum | Optimum | Optimum | Favorable |

TABLE 2

| | | Compar- | Compar- | Compar- | Compar- | Compar- | Compar- | Compar- | Compar- | Compar- |
|---|---|---|---|---|---|---|---|---|---|---|
| | | ative | ative | ative | ative | ative | ative | ative | ative | ative |
| | | Example 1 | Example 2 | Example 3 | Example 4 | Example 5 | Example 6 | Example 7 | Example 8 | Example 9 |
| Micro | Inner diameter (μm) | 30 | 130 | 70 | 70 | 70 | 70 | 70 | 70 | 40 |
| recess part | Depth (μm) | 60 | 60 | 15 | 120 | 60 | 60 | 60 | 60 | 120 |
| | Interval (μm) | 200 | 200 | 200 | 200 | 150 | 330 | 200 | 200 | 125 |
| | Arrangement | Regular | Regular | Regular | Regular | Regular | Regular | Regular | Random | Regular |
| | Unevenness | Micro | Micro | Micro | Micro | Micro | Micro | Micro | Micro | Micro |
| | | recess | recess | recess | recess | recess | recess | recess | recess | convex |
| Ultramicro | Height (μm) | 8 | 8 | 8 | 8 | 8 | 8 | 20 | 8 | — |
| convex part | | | | | | | | | | |
| Evaluation | Feel | Smooth | Dry | Smooth | Dry | Dry | Smooth | Rough | Very Rough | Dry |
| result | Pressure resistance | Excellent | Excellent | Excellent | Excellent | Excellent | Excellent | Excellent | Excellent | Excellent |
| | Wear resistance | Excellent | Poor | Excellent | Poor | Poor | Excellent | Poor | Excellent | Poor |
| | Rubbing noise | 2 | 1 | 4 | 1 | 1 | 4 | 1 | 1 | 1 |
| | Overall evaluation | Unsuitable | Unsuitable | Unsuitable | Unsuitable | Unsuitable | Unsuitable | Unsuitable | Unsuitable | Unsuitable |

### Evaluation Results

When Examples 1 to 9 and Comparative Examples 1 to 9 were compared, all the evaluation results of the feel, the pressure resistance, the wear resistance, and the rubbing noise were excellent in Examples 1 to 9.

As is clear from the evaluation results, it was demonstrated that the synthetic resin leather of Examples 1 to 9 had good dry feel as natural leather or “Smooth-Dry” feel, which refers to an intermediate feel between dry feel and smooth feel, had excellent wear resistance and pressure resistance, and was capable of reducing rubbing noise.

On the other hand, any of the evaluation results of the feel, the pressure resistance, the wear resistance, and the rubbing noise were poor in Comparative Examples 1 to 9.

In Comparative Example 1, the micro recess parts (the bottom face parts and the inner side face parts) had a too small average inner diameter and were not likely to be elastically deformed due to contact with the hand, finger, or the like of a user, and therefore, the evaluation result of the feel was “Smooth”, which was poor.

In Comparative Example 2, the micro recess parts (the bottom face parts and the inner side face parts) had a too large average inner diameter and the inner side face parts of the recess parts were likely to be elastically deformed when the surface portion was touched by the hand, finger, or the like of a user, and therefore, the evaluation result of the feel was “Dry”, which was good. However, since the inner diameters of the micro recess parts and the diameters of the remaining portions of the surface were relatively close, the surfaces were favorably engaged with each other when rubbed with each other, and therefore, the evaluation result of the rubbing noise was poor. Also, the surface and the inner side face parts were elastically deformed more than necessary due to contact with the hand, finger, or the like of a user, and therefore, the evaluation result of the wear resistance was also poor.

In Comparative Example 3, the micro recess parts (the bottom face parts and the inner side face parts) had a too small average depth (they relatively had an excessively large diameter and an excessively small depth), and the bottom face parts were extremely close to the surface of the skin layer. Thus, the hand, finger, or the like of a user also touched the bottom face parts of the micro recess parts, and therefore, the evaluation result of the feel was “Smooth”, which was poor.

In Comparative Example 4, the micro recess parts (the bottom face parts and the inner side face parts) had a too large average depth (they relatively had an excessively small diameter and an excessively large depth) and were likely to be elastically deformed. The friction increased when the surfaces were rubbed with each other, and therefore, the evaluation result of the rubbing noise was poor. Also, the bottom face parts and the inner side face parts were elastically deformed more than necessary due to contact with the hand, finger, or the like of a user, and therefore, the evaluation result of the wear resistance was also poor.

In Comparative Example 5, the average interval between the centers of the micro recess parts (the bottom face parts and the inner side face parts) was too small, and the density of the micro recess parts relative to the surface of the skin layer was high. Thus, when the hand, finger, or the like of a user touched the bottom face parts, the inner side face parts were likely to be elastically deformed, and therefore, the evaluation result of the feel was “Dry”, which was good, but the evaluation result of the wear resistance was poor due to the inner side face part being likely to be elastically deformed.

In Comparative Example 6, the average interval between the centers of the micro recess parts (the bottom face parts and the inner side face parts) was too large, and the density of the micro recess parts relative to the surface of the skin layer was low. Thus, when touching the bottom face parts, the hand, finger, or the like of a user directly frequently touched the surface 2s of the skin layer 2, and therefore, the evaluation result of the feel was “Smooth”, which was poor.

In Comparative Example 7, the ultramicro convex parts were too high, and thus when touched by the hand, finger, or the like of a user, the surface felt a sandy “Rough” feel, and the evaluation result was poor.

In Comparative Example 8, since the micro recess parts were arranged in an irregular (random) manner, the micro recess parts and portions in which the micro recess parts were not arranged were located at a random density on the surface of the skin layer, and therefore, a portion of the surface was determined as “Very Rough”, which was the poor evaluation result.

In Comparative Example 9, the micro convex parts (micro protrusions) were formed instead of the micro recess parts and were likely to be elastically deformed when touched by the hand, finger, or the like of a user, and therefore, the evaluation result of the feel was “Dry”, which was good, but the evaluation results of the wear resistance and the rubbing noise were poor.

Note that, in Examples 1 to 9 and Comparative Examples 1 to 9 above, the evaluation samples in which the multiple substantially cylindrical micro recess parts having a flat bottom face part relative to the surface of the skin layer were intermittently and regularly (at regular intervals in a staggered configuration) arranged were used for the evaluation, but there is no limitation thereto, and the same evaluation results as those of Examples 1 to 8 were obtained even when evaluation samples in which the multiple hemispherical micro recess parts having a curved bottom face part were regularly (at regular intervals in a staggered configuration) arranged were used, or evaluation samples in which the multiple micro recess parts having a substantially cylindrical shape, a prism shape, or a hemispherical shape were regularly (at regular intervals in a lattice configuration) arranged were used.

The present invention may have configurations of the items listed below.

### Item 1

Synthetic resin leather including: a base material; and
a skin layer that is stacked on the base material and is made of a synthetic resin capable of being elastically deformed,
wherein multiple micro recess parts are intermittently and regularly formed on a surface of the skin layer, and the multiple micro recess parts form multiple bottom face parts that are located at a substantially constant depth from the surface of the skin layer, and multiple inner side face parts that extend from the surface of the skin layer to the multiple bottom face parts and are capable of being elastically deformed.

### Item 2

The synthetic resin leather according to item 1, wherein the multiple micro recess parts are formed in a substantially cylindrical shape with the multiple bottom face parts being flat, or the multiple micro recess parts are formed in a hemispherical shape with the multiple bottom face parts being curved.

### Item 3

The synthetic resin leather according to item 1 or 2, wherein an average ratio between an inner diameter of each of the multiple micro recess parts on the surface of the skin layer, a depth of the micro recess part from the surface to the bottom face part, and an interval between the micro recess parts is 2.0 to 5.5:1.5 to 5.0:9.0 to 15.5, and the interval is larger than the inner diameter.

### Item 4

The synthetic resin leather according to any one of items 1 to 3, wherein the depth from the surface to the bottom face part is smaller than a thickness of the skin layer.

### Item 5

The synthetic resin leather according to any one of items 1 to 4, wherein multiple ultramicro convex parts are formed to provide a sandy texture on a portion of the surface of the skin layer other than the micro recess parts, and
an average height of the multiple ultramicro convex parts is smaller than the depths of the multiple micro recess parts.

### Item 6

A method for manufacturing synthetic resin leather, including: a stacking process for forming a skin layer made of a synthetic resin capable of being elastically deformed on a base material; and
an embossing process for intermittently and regularly forming multiple micro recess parts over an entire surface of the skin layer,
wherein, in the embossing process, multiple bottom face parts that are located at a substantially constant depth from the surface of the skin layer, and multiple inner side face parts that extend from the surface of the skin layer to the multiple bottom face parts and are capable of being elastically deformed are embossed to form the multiple micro recess parts.

### Item 7

The method for manufacturing synthetic resin leather according to item 6, wherein an average ratio between an inner diameter of each of the multiple micro recess parts on the surface of the skin layer, a depth of the micro recess part from the surface to the bottom face part, and an interval between the micro recess parts is 2.0 to 5.5:1.5 to 5.0:9.0 to 15.5, and the interval is larger than the inner diameter.

### Item 8

The method for manufacturing synthetic resin leather according to item 6 or 7, wherein, in the embossing process, multiple ultramicro convex parts are formed to provide a sandy texture on a portion of the surface of the skin layer other than the micro recess parts, and
an average height of the multiple ultramicro convex parts is smaller than the depths of the multiple micro recess parts.

The preceding examples can be repeated with similar success by substituting the generically or specifically described reactants and/or operating conditions of this invention for those used in the preceding examples.

From the foregoing description, one skilled in the art can easily ascertain the essential characteristics of this invention and, without departing from the spirit and scope thereof, can make various changes and modifications of the invention to adapt it to various usages and conditions.

### REFERENCE SIGNS LIST

1 Base material
1a Front side surface
2 Skin layer
2s Surface
2b Back surface
21 Micro recess part
21b Bottom face part
21w Inner side face part
21r Inner diameter of micro recess part
21p Interval between micro recess parts (average interval between centers)
21d Depth of micro recess part
22 Ultramicro convex part
22h Height of ultramicro convex part (average height)
3 Underlayer
A Synthetic resin leather
B Stacked body
C Calender molding machine
E Embossing roller
E1 Embossed pattern
H Heater
T Touch roller

1. Synthetic resin leather comprising:
a base material; and
a skin layer that is stacked on the base material and is made of a synthetic resin capable of being elastically deformed,
wherein multiple micro recess parts are intermittently and regularly formed on a surface of the skin layer, and
the multiple micro recess parts form multiple bottom face parts that are located at a substantially constant depth from the surface of the skin layer, and multiple inner side face parts that extend from the surface of the skin layer to the multiple bottom face parts and are capable of being elastically deformed.

2. The synthetic resin leather according to claim 1, wherein the multiple micro recess parts are formed in a substantially cylindrical shape with the multiple bottom face parts being flat, or the multiple micro recess parts are formed in a hemispherical shape with the multiple bottom face parts being curved.

3. The synthetic resin leather according to claim 1, wherein an average ratio between an inner diameter of each of the multiple micro recess parts on the surface of the skin layer, a depth of the micro recess parts from the surface to the bottom face parts, and an interval between the micro recess parts is 2.0 to 5.5:1.5 to 5.0:9.0 to 15.5, and the interval is larger than the inner diameter.

4. The synthetic resin leather according to claim 1, wherein a depth from the surface to the bottom face parts is smaller than a thickness of the skin layer.

5. The synthetic resin leather according to claim 1,
wherein multiple ultramicro convex parts are formed to provide a sandy texture on a portion of the surface of the skin layer other than the micro recess parts, and
an average height of the multiple ultramicro convex parts is smaller than the depths of the multiple micro recess parts.

6. A method for manufacturing synthetic resin leather, comprising:
a stacking process for forming a skin layer made of a synthetic resin capable of being elastically deformed on a base material; and
an embossing process for intermittently and regularly forming multiple micro recess parts over an entire surface of the skin layer,
wherein, in the embossing process, multiple bottom face parts that are located at a substantially constant depth from the surface of the skin layer, and multiple inner side face parts that extend from the surface of the skin layer to the multiple bottom face parts and are capable of being elastically deformed are embossed to form the multiple micro recess parts.

7. The method for manufacturing synthetic resin leather according to claim 6, wherein an average ratio between an inner diameter of each of the multiple micro recess parts on the surface of the skin layer, a depth of the micro recess parts from the surface to the bottom face parts, and an interval between the micro recess parts is 2.0 to 5.5:1.5 to 5.0:9.0 to 15.5, and the interval is larger than the inner diameter.

8. The method for manufacturing synthetic resin leather according to claim 6,
wherein, in the embossing process, multiple ultramicro convex parts are formed to provide a sandy texture on a portion of the surface of the skin layer other than the micro recess parts, and
an average height of the multiple ultramicro convex parts is smaller than the depths of the multiple micro recess parts.
